(19) United States
(12) Patent Application Publication
(10) Pub. No.: US 2002/0046044 A1
(43) Pub. Date: Apr. 18, 2002

(54) Internet based program for generating roof contract specifications

(76) Inventors: Robert G. Johnston, Parkland, FL (US); Edward J. Murton, Pompano Beach, FL (US)

Correspondence Address: MELVIN K. SILVERMAN, 4901 NORTH FEDERAL HIGHWAY, SUITE 440, FORT LAUDERDALE, FL, 33308, US

(21) Appl. No.: 09/876,864

(22) Filed: Jun. 8, 2001

Related U.S. Application Data
(60) Provisional application No. 60/209,459, filed on Jun. 6, 2000.

(51) Int. Cl. G06F 17/60

(52) U.S. Cl. 705/1

(57) ABSTRACT

An Internet based software program employs geographic or appropriate zip code information, together with date with respect to type of structure, e.g., commercial, institutional, or residential. A user executes a questionnaire consisting of parameters of a roof to be replaced or repaired and, integrally therewith, accesses decision support databases for each question of such questionnaire, in which the support databases also provide access to a library of reference details and diagrams to illustrate to the user the physical appearance of the various options expressed in the decision support databases for respective questions of the questionnaire. The questionnaire is, additionally, provided with a variety of prompts, hints, warnings and system suggestions to aid the user in navigation through the questionnaire and its databases. The system then generates a project specification, compliant with local, state, and federal building codes, this inclusive of priority rules, thus producing an operational roofing specification inclusive of instructions to bidders, general legal conditions, general property protections, environmental requirements, application and permit procedure, insurance and licensing requirements, unit pricing, metal/flashing section, sealant section, and bid form.

### REFERENCE TO RELATED APPLICATION

This case is a non-provisional conversion of application Ser. No. 60/209,459 and claims the benefit thereof under 35 U.S.C. 119(e).

### BACKGROUND OF THE INVENTION

Software programs for use by general contractors are known in the art as, for example, is represented by U.S. Pat. No. 5,903,010 (1999) to Murdock, et al, entitled Method Of Describing A Building Structure. However, to the knowledge of the within inventors, there does not exist software, whether internet based or otherwise, capable of providing to a potential end user, such as a property owner or local contractor, a complete roofing specification for a particular zip code within the United States capable of taking into account all applicable local, state, and federal building codes, while providing decision support databases (DSDs) for online use by the user in a decision tree/questionnaire process which, when completed, can produce a fully usable roofing and/or waterproofing specification and optimized as to the numerous variables.

Software such as the above is particularly adaptable to use through the Internet such that individuals, businesses and institutional entities, in whatever geographical location, can secure, at minimal cost, a high quality roofing specification including associated suggestions as to qualified local contractors, product vendors, and pre-construction professionals such as architects, engineers, and attorneys. In the absence of such a system, the end user often has little basis upon which to measure the integrity or competence of a local roofing contractor, or to communicate therewith in an informed fashion. It is thereby apparent that a long felt need has existed for such an on-line facility.

### SUMMARY OF THE INVENTION

The present invention relates to an internet based software program in which, on the basis of a geographic, GPS (geo-stationary positioned satellite) or an appropriate zip code, together with information with respect to type of structure, e.g., commercial, institutional, or residential, a user may execute a questionnaire consisting of various parameters of a roof to be replaced or repaired and, integrally therewith, access decision support databases for each question of such questionnaire, wherein the supporting databases themselves provide access to a library of reference details and diagrams to illustrate to the user the physical appearance of the various options expressed in the decision support databases of respective questions of the questionnaire.

The questionnaire is, additionally, provided with a variety of prompts, hints, warnings and system suggestions to aid the user in navigation through the questionnaire and its supporting databases. Upon completion of the questionnaire, the user is able to express product/vendor preferences as to various aspects of the roofing project. Thereupon, the system generates a project specification, compliant with local, state, and federal building codes, the same inclusive of priority rules, thus producing an operational roofing specification inclusive of instructions to bidders, general legal conditions, general property protections, environmental requirements, application and permit procedure, insurance and licensing requirements, unit pricing, metal/flashing section, sealant section, and bid form. Also furnished to the user is a list of approved manufacturers for the geographic region, links to contractor promotional information, and contractor evaluations and recommendations thereon from the system itself.

It is accordingly an object of the present invention to provide an internet based software system for generating a fully code compliant roofing and/or waterproofing specification which is zip code specific to any location in the United States and usable in residential, commercial and institutional application.

It is a further object to provide a software system of the above type in which an end user, through the execution of a roof parameter questionnaire, can, at nominal cost, secure a fully usable construction document.

It is another object of the invention to provide a software program which, through a variety of databases, can provide to the user suggestions and options across a broad range of parameters inclusive of visual displays of roofing types, deck types, roof pitch types, supporting metal elements, and a variety of accessories.

It is a yet further object to provide an Internet based program of in which an end user may be furnished with information, suggestions, evaluations, prompts, hints and warnings relative to construction products, contractors and other issues.

It is a further object to provide a software system of the above type which is user friendly to lay people not having any background in the area of roofing or waterproofing and/or that are unknowledgeable with respect to the range of options, both in terms of products and services, which exist a roofing project.

The above and yet other objects and advantages of the present invention will become apparent from the hereinafter set forth Brief Description of the Drawings and Detailed Description of the Invention as set forth herein.

### BRIEF DESCRIPTION OF THE DRAWINGS

FIG. 1 is a flow diagram showing log-on to the homepage of the present system and the choice points therefrom.

FIG. 2 is a flow diagram showing basic choice options, relative to forms of construction, which follow the diagram of FIG. 1, and further showing a description and cost relative to a roofing specification which the system user is solicited to purchase.

FIG. 3 is a flow chart providing an overview of the balance of the roofing specification system and showing generally therein geographic identification, the questionnaire and questionnaire decision support databases, product selection options, and the compilation of a customized specification.

FIG. 4 is a detailed flow diagram of the system questionnaire, its decision support databases, and the library of searchable graphic details and diagrams.

FIG. 5 is a flow diagram showing in detail the contents of the customized specification, its supporting building code databases, its database for determining priority rules as between city, state and federal codes, and contractor select options and evaluations.

FIGS. 6 to 9 are examples of prompts, hints, warnings and suggestions, referenced in FIG. 4.

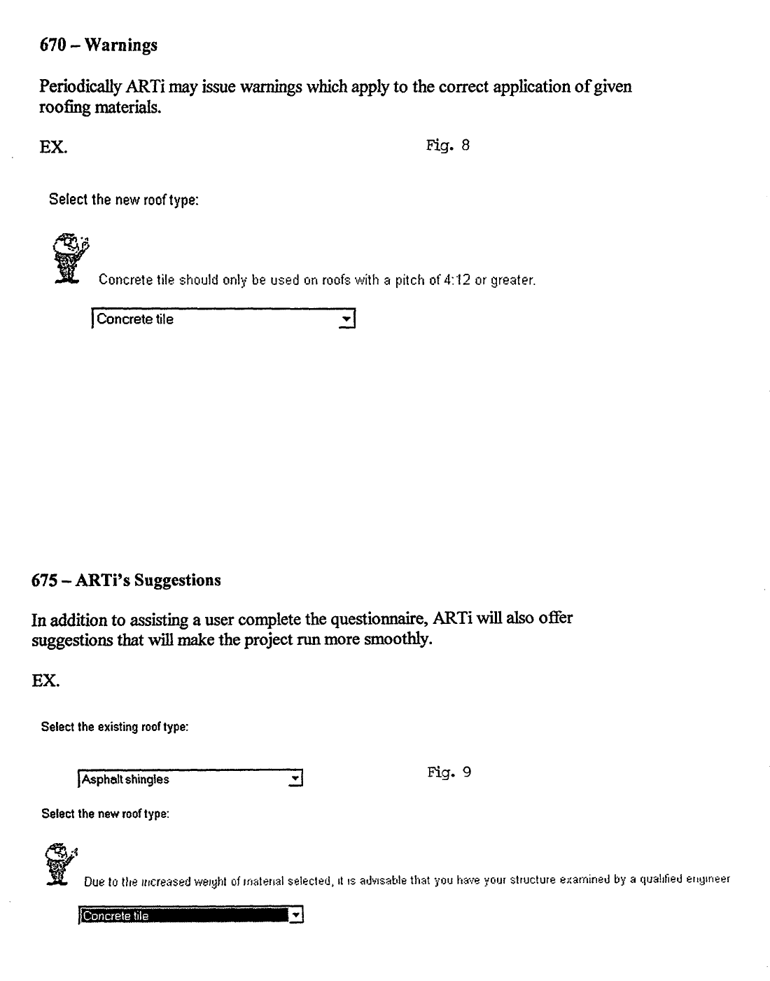

### DETAILED DESCRIPTION OF THE INVENTION

The internet based software system as set forth below is designed to enable consumers, as well as professionals, to obtain a customized individual specification for a particular project, whether residential, commercial, or institutional, to download a resulting specification, duplicate the same, and then to solicit competitive bids, from suggested contractors, for their homes or facilities. Various aspects of the same will, it is anticipated, be made available to architects, engineers, consultants, contractors, facility managers, institutional officials, commercial property owners, and private homeowners. The foregoing system may be viewed as a “specification on demand” system wherein by a proper completion of an electronic questionnaire, as supported by various decision support databases and a library of visual/graphic details and diagram, any member of the public can download a complete geographically code compliant specification for a roofing or waterproofing project.

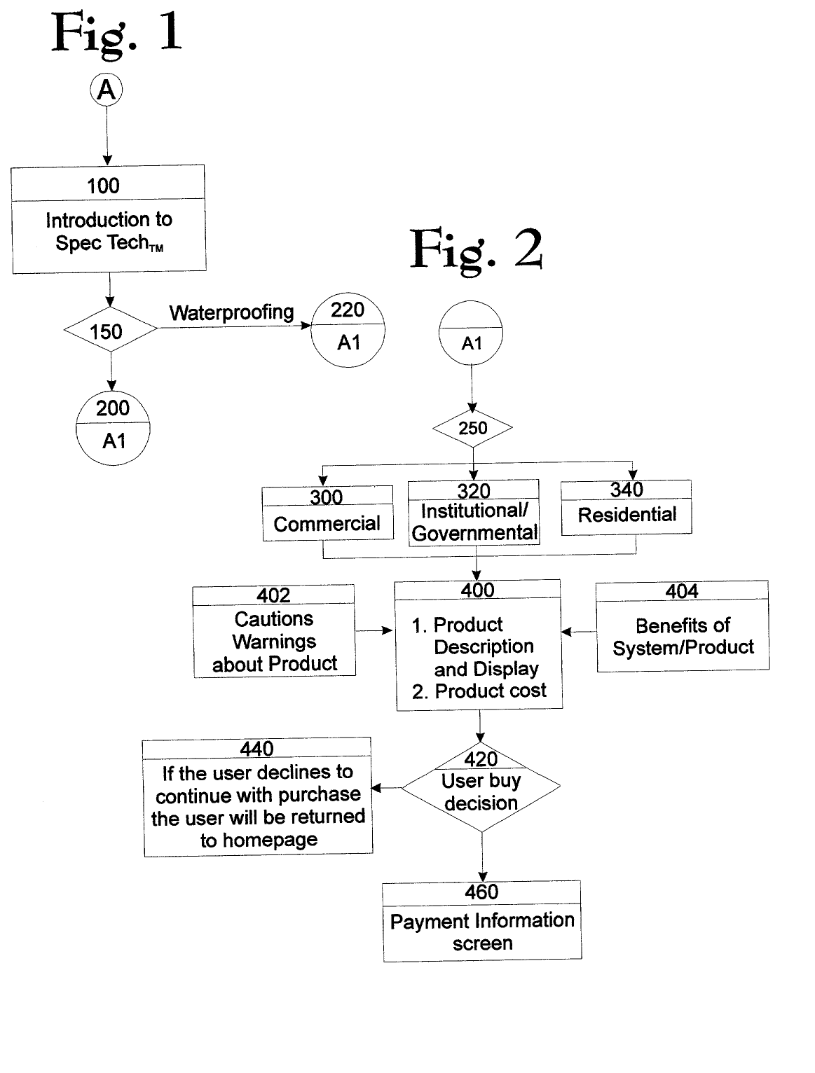

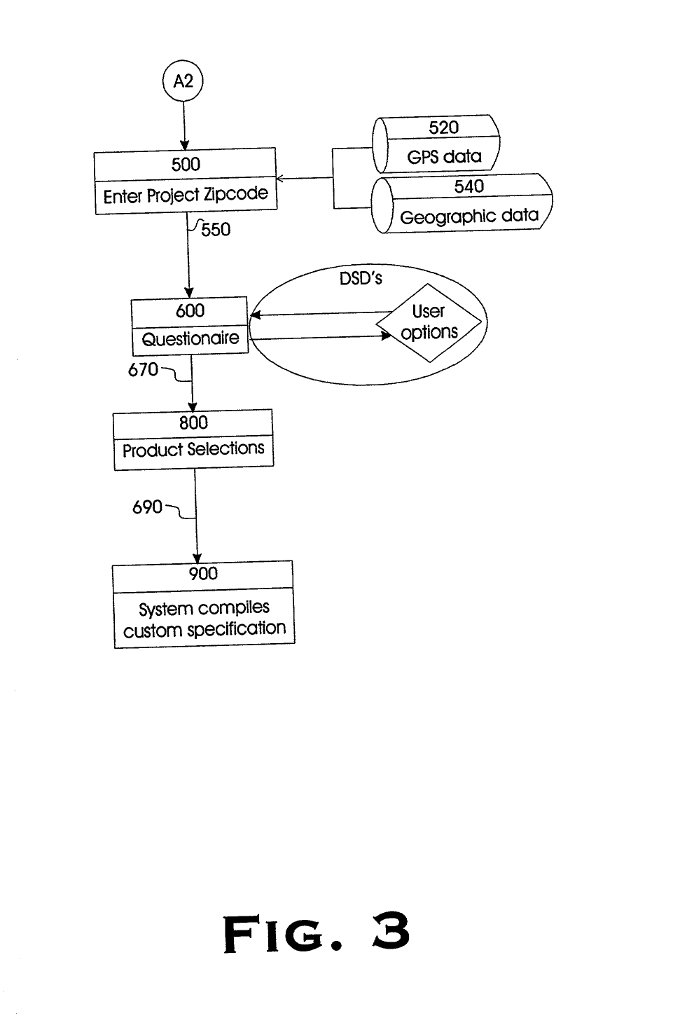

Entrance to the instant software system is shown in flow diagram format in FIG. 1, that is, after log-on A the user reaches the system homepage 100, referenced in FIG. 1 as SPEC TECH. After review of some basic introductory material, as well as a brief site access agreement, the user is asked, at choice point 150 to indicate whether he is interested in roofing 200 or waterproofing 220. This answer will affect the content of questionnaire 600, discussed below. However, in either event, the program will then (see FIG. 2) bring the user to decision point 250 where he must indicate his area of interest as between commercial 300, institutional 320, or residential 340 whereupon, through the use of an animated icon known as ARTi, The Certified Cyber-roof Consultant, the user is provided with a brief tour of the operation of the program, the product cost, the benefits of using the system generated specification to bid upon a roofing or waterproofing project (block 404). This point is indicated at block 400 of FIG. 2. At block 202 cautions and warnings about the product are explained. Therein a toll free phone number is provided for assistance at any time during navigation of the program. At decision point 420 the user must decide whether or not to buy the system service. Should he choose not to proceed (block 440) the user is returned to the home page 100. Should the user choose to proceed, he is taken to a payment information screen 460, whereupon a credit card transaction is effected over a secure server supplied by the host. If the user's credit card information, name, address, city and zip code data results in an approved transaction, the user will receive a confirmation number. If the transaction is declined, the user will be given options to attempt the purchase with another credit card or will return to the home page. When an approved transaction occurs, an e-mail will be sent to a system e-mail account as well as other advice to the system administrator.

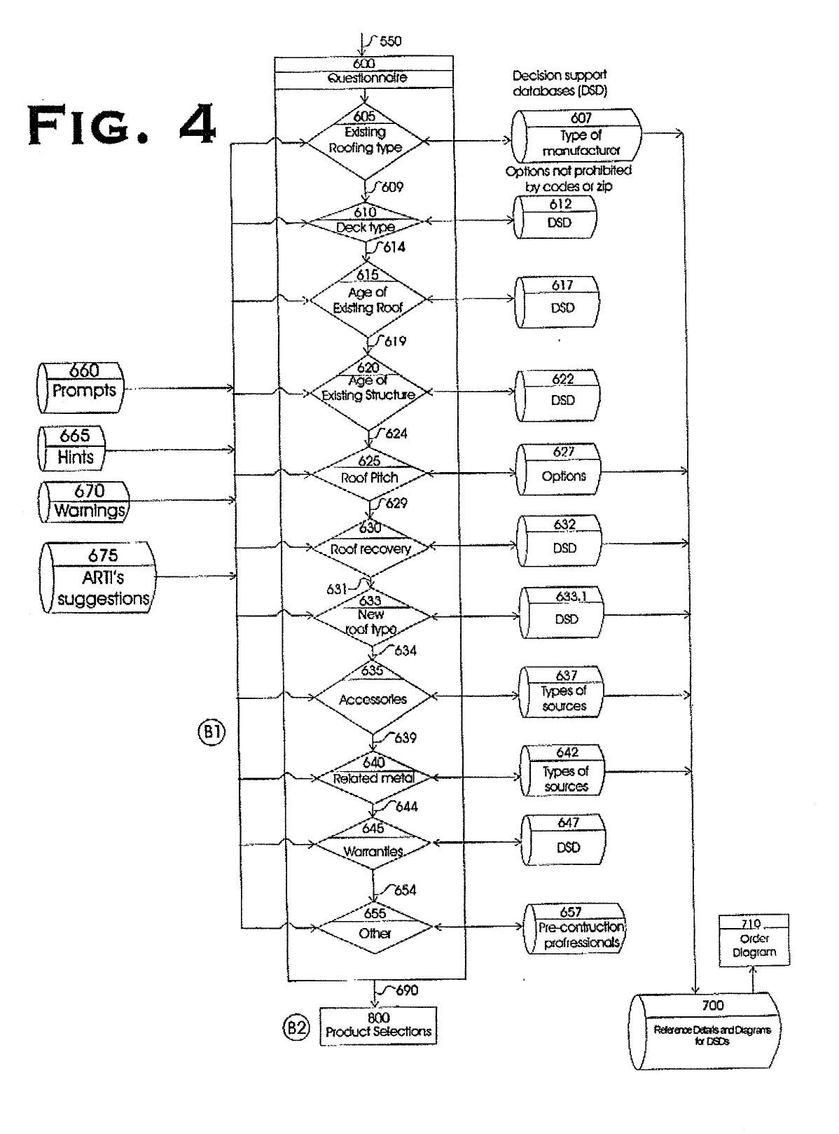

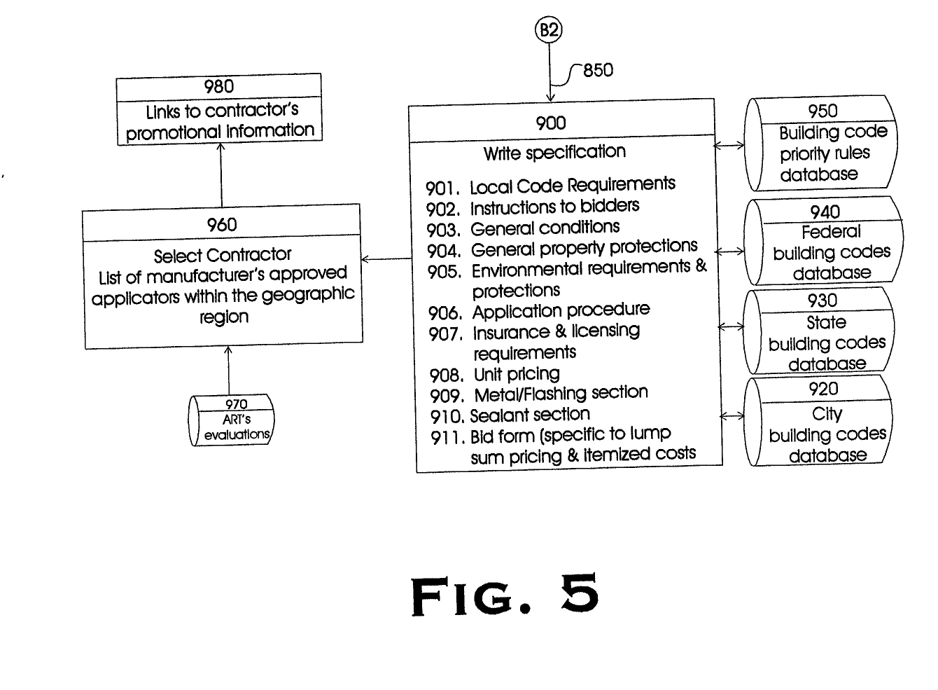

Turning to FIG. 3, the user is asked to enter a project specific zip code. However, in the event that zip code information is not available to the user, coordinates from a geo-stationary positioned satellite (database 520) or geographical data in combination with software such as the Chicago Mapping System (database 540) may be used to produce a proper zip code for entry at block 500. Thereupon path 550 is taken thus leading the user to questionnaire 600 with its decision support database (DSDs) which are the core of the instant system The same is shown in greater detail in FIG. 4.

Continuing to questionnaire 600 (see FIG. 4), the system user is presented with a multi question questionnaire consisting of various questions, most of which are multiple choice in nature. As such, there is provided a decision support database for each question which provides to the user a list of answer options which are not prohibited by a building code or other regulation as determined at the zip code entry step 500. Supportive of the decision support databases (the DSDs) is a library 700 of reference details and diagrams which are provided to illustrate the options presented by the DSDs. These graphical details are not only searchable but, as well, may be downloaded for a fee as in indicated in FIG. 4 by block 710.

At the beginning of questionnaire 600, the user is asked at Question 605, to identify his existing roof type. This will normally comprise one of the following:

Mineral surface roll roofing

Mineral surface roll roofing double coverage.

Laminated double layer strip shingle.

Single thickness shingle strip.

Self sealing strip shingle 3-tab.

Self-sealing strip shingle no cutout.

T-lock.

Slate.

Tern Metal.

Metal roof systems.

Clay tile flat.

Clay tile Spanish S.

Clay tile barrel.

Clay interlocking profile tile.

Clay interlocking flat tile.

Clay plain flat non-interlocking tile.

Concrete interlocking profile tile.

Concrete interlocking flat tile.

Concrete plain flat non-interlocking tile.

Concrete flat tile.

Concrete Spanish S Tile.

Concrete barrel tile.

Fiberglass shingles.

Stone shingles

Cedar wood shingles.

Built up.

Modified bitumen.

Thermoset single-ply.

Thermoplastic shingle-ply.

Sprayed polyurethane foam.

Liquid applied coatings.

Where it is necessary or useful to know the type of manufacturer of the existing roof, this information may be searched through database 607.

Proceeding along Line 609, the user is asked at Point 610 to identify the deck type. The answer options thereto are stored in DSD 612 and would typically comprise the following:

Wood plank.

Wood tongue and groove.

Plywood ½, ⅝, ¾ thickness,

Metal rib.

Tectum—wood fiber.

Concrete.

Light weight insulating concrete.

Gypsum.

Pre-cast concrete.

Other (as may be specified by the DSD).

Proceeding along Line 614, the user is then asked to enter the approximate age of the existing roof at question 615. The available options, as stored in DSD 617 will be the following:

1. 0 to 5 years.

2. 5 to 10 years.

3. 10 to 15 years.

4. 15 to 20 years.

5. 20 to 25 years.

6. More than 25 years.

Proceeding along Line 619, the user then reaches Question 620 relative to age of the existing structure. From DSD 622, the user is presented with the following possible answers:

1. 0 to 10 years.

2. 10 to 20 years

3. 20 to 30 years.

4. 30 to 40 years.

5. 40 to 50 years.

6. More than 50 years.

Proceeding along line 624 to Question 625, the user is then asked to indicate the approximate pitch/slope of the roof. The possible answers thereto are provided in DSD 627, which are as follows:

Flat.

1/12

2/12

3/12

4/12

5/12

6/12

7/12

8/12

9/12

10-15/12

15/20/12

Proceeding along line 629 to Question 630 relative to roof recovery, the user is asked to indicate, with the help of DSD 632, his project objectives, for example, roof replacement, replacement of deck, or new construction. At any point in the questionnaire, any of prompts 660, hints 665, warning 670, or ARTi suggestions 675 may appear on the screen to assist or guide the user. This is particularly true with respect to the various new roof questions which follow.

Proceeding along Line 631 to Question 633, the user is asked to indicate the new roof type of interest. This question is supported by the menu of question 605 and DSD 633.1 which contains the information of answer 605 and has access to the searchable library 700 of graphic details and diagrams to which the user may make reference in determining his answer to Question 633. As such, the user is able to access actual images and diagrams to obtain a better idea of what a particular roof type of a particular manufacturer would look like. As above noted, at any point in the questionnaire, any of said prompts, hints, warning or suggestions may appear. For example, if the user indicates a preference for a new roof type at Question 633 which is incompatible, or may require an expert opinion of a pre-construction profession such as an architect or engineer, relative to a prior answer, e.g., deck type or roof pitch, a pop-up ARTi window with such a hint, warning, or suggestion will appear regarding that issue.

Proceeding along Line 634 of FIG. 4, the user is asked to indicate a “yes” or “no” relative to various accessory options which appear at Question 635 as supported by DSD 637. For example, he will be asked to answer yes or no with respect to the following possible accessories: soffit, fascia, gutters, downspouts, chimney, skylight, turbine vents, plumbing vents, and other vents. Sources of such accessories are accessible through DSD 637 and pictures thereof through the visual database 700.

Proceeding along Line 639 to Question 640, the user is asked to indicate the type of metal he wishes to use. Whereupon he may choose between various options including copper, lead, stainless steel, and galvanized metal.

Proceeding along Line 644 to Question 645, the user is asked to indicate the duration of a desired product warranty for the project. The typical choices therefore will be that of 15 years, 20 years, 25 years, and more than 25 years. Legal and other details respecting the issue of warranties are accessible through DSD 647.

Proceeding along Line 654 to Question 655, other questions may appear, this potentially as a function of zip code selected or of particular answers to prior questions, many of which will require access to pre-construction professionals such as engineers, architects or lawyers. The names of such professionals for the zip code selected at block 500 of the program are available through DSD 657. As above noted, use is made of the animated figure known as ARTi, the function of which is to render more explicit the hints, warnings and suggestions of databases 655, 670 and 675 respectively, referenced above. For example, at Question 640, ARTi might appear and make a comment such as the following:

“When specifying a roof system that you expect to get 20, 25 or more years of service of, it is always a good idea to specify copper, lead or stainless steel for the valleys.”

Further, where ARTi believes that the user has made a selection which does not conform to industry standard roofing practice, it will automatically issue a caution or warning and, as well, will make appropriate suggestions and recommendations at that particular point in the questionnaire 600. In this sense, ARTi may be viewed as the programmed intelligence of the system.

Where an issue of product selection occurs, as in the case at block 800 (which through path 690 follows the questionnaire 600), ARTi provides recommendations relevant to selections/answers made by user and provides links to manufacturers' promotional information. Such suggestions may also appear at other points of the programs as is set forth below.

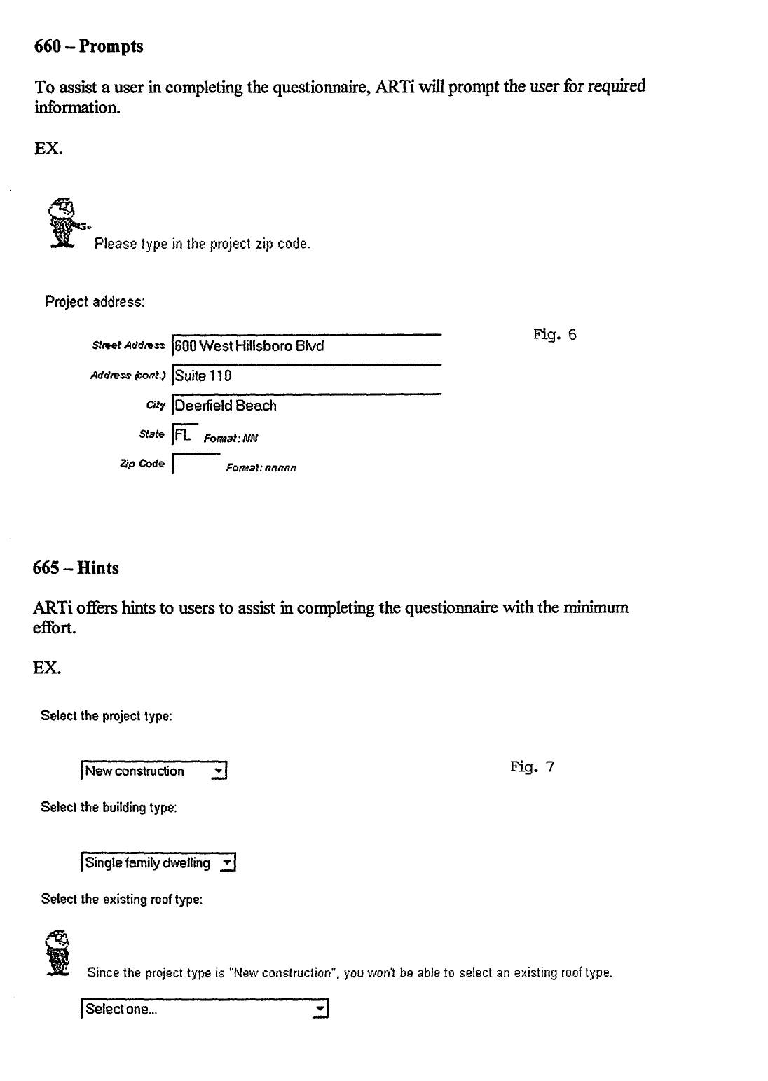

Proceeding past product selections 800, a step which will be an option to those unknowledgeable in the building industry, one proceeds to block 900 (see FIG. 5). Therein, the user is provided with a fully code compliant written specification which, through the use of city, state, and federal building code databases 920, 930 and 940 respectively, as well as a building code priority database 900, comprises an entire specification including the most stringent applicable code, instructions to bidders, general conditions, general property protections, environmental requirements and issues, application/permit procedure, insurance and licensing requirements, unit pricing, metal/flashing section, sealant section, and bid form inclusive of lump sum pricing and itemized costs. An example of a specification, produced by the present system, appears as follows:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

After the specification is printed, the user is led to block 960 which enables him to browse contractors and a manufacturer's list of approved applicators (of the manufacturers product) within a geographical sector (typically 20 to 30 miles with the exception of isolated areas of the country). Therein, the user is provided with both ARTi's evaluations of contractors within the geographical area (database 970) and links to the area contractors' promotional information (block 980).

It has been discovered by the within inventors that upon about 40 combinations of city, state and federal building codes (as stored in said databases 920, 930 and 940), taken in combination with the DSD supported answers to the questions of questionnaire 600, can enable specification 900 to be produced without requirement of a costly mainframe computer. Rather, the same can be accomplished through the use of far more economical hardware such as a network server

After the user has completed review of the information of blocks 960, the evaluations of database 970, and the contractor links 980, ARTi instructs the user either to send an e-mail direct to a selected contractor or to make copies of the specification and distribute them to various approved contractors (obtained at block 960) for purposes of bidding on the specification.

With respect to commercial or institutional applications, the same will apply if, responsive to choice point 250 in FIG. 2, selection is made of commercial 300 or institutional 320. In such event, questionnaire 600 is much more detailed as is necessary for commercial and institutional applications. In addition, applicable building codes (see FIG. 5) will of course differ for commercial and institutional applications.

In order to accommodate the multitude of additional variables involved in a commercial construction, ARTi, The Certified Cyber-roof Consultant icon, will be much more prevalent on the commercial questionnaire. That is, enhanced numbers of hints 665, warning 670 and suggestions 675 will occur in the commercial and institutional questionnaires. Therein, the user will be asked various questions about surveys and examinations of any existing roof and deck. Also, the resulting specification will be much more detailed for commercial users.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

We claim:

1. An Internet-based method of generation of a roofing contract specification, the method comprising the steps of:
(a) identifying a given roofing project by geographical data sufficient to produce a geographical code for said project;
(b) advising a plurality of decision support databases (DSDs) of said code to thereby block use of geographic code prohibited data by said DSDs;
(c) presenting to a user a questionnaire comprising a plurality of questions related to a roofing related parameter relevant to said project;
(d) for each question of said questionnaire, providing a drop-down box including a linked data list including prospective answers to said roofing parameter to which a given question relates;
(e) hyperlinking one or more elements of said data list to a corresponding one of said DSDs to thereby furnish additional question-related information to assist the user in answering a given question;
(f) hyperlinking one or more of said DSDs to a searchable database of graphic details and diagrams relative to a given DSD supported question of said questionnaire;
(g) during presentation of each question to said user, providing one or more pop-up windows to display one or more types of system intelligence selected from the categories of intelligence consisting of prompts, hints, warnings, suggestions, and combinations thereof; and
(h) submitting said questionnaire, when completed, to a specification-generating program, for taking into account construction, safety and environmental codes applicable with said geographic code of Step (a) above, insurance and licensing requirements for contractors, local permitting procedure, roofing installation procedure, and general legal conditions.

2. The method as recited in claim 1, further comprising the step of:
(1) providing a bid form for submission to prospective contractors, said form inclusive of bidder instructions relative to lump sum price and itemized costs of the project.

3. The method as recited in claim 1, in which:
said Step (a) includes the step of expressing said geographic data as a U.S. Postal Zip Code.

4. The method as recited in claim 1 in which said Step (g) comprises the step of:
responsive to particular user responses to particular questions of said questionnaire, providing one or more pop-up windows within one or more of said system intelligence categories.

5. The method as recited in claim 1 further comprising the step of:
after said Step (g), selecting by the user of a product or manufacturer preference regarding one or more of each parameter of questionnaire answers.

6. The method as recited in claim 1 in which said Step (h) further includes the step of:
providing at least one of contractual material unit pricing, type of metal/flashing to be employed, and type of sealant to be employed.

7. The method as recited in claim 2 in which:
in association with said Step (h), providing hyperlinks for submission of the specification and bid form to selectable area contractors.

8. The method as recited in claim 2, further comprising the step of:
providing means for e-mailing said bid form, with specification, to prospective contractors within the users area.

9. The method as recited in claim 7, further comprising the step of:
providing hyperlinks to contractor websites to thereby enable a system user to obtain information relative to different area contractors prior to making a submission thereto.

10. The method as recited in claim 7, further comprising the step of:
providing hyperlinks to, or drop down boxes relative to evaluations of area specific contractors.

11. The system as recited in claim 2, in which said Step (h) further includes the step of:
providing hyperlinks to geographic-specific area manufacturers and distributors of roofing products within categories recited in said specification.
